(19) United States
(12) Patent Application Publication
(10) Pub. No.: US 2021/0117981 A1
(43) Pub. Date: Apr. 22, 2021

(54) Methods, Device, Block Chain Node, Computer-readable Media and System for Carbon Recording and Trading based on Block Chain

(71) Applicant: VeChain Global Technology, S.AR.L, Luxembourg (LU)

(72) Inventors: Xinli TIAN, Shanghai (CN); Jianliang GU, Shanghai (CN); Ziheng ZHOU, Shanghai (CN)

(21) Appl. No.: 15/733,359

(22) PCT Filed: Jan. 10, 2019
(86) PCT No.: PCT/CN2019/071066

§ 371 Date: Jul. 9, 2020

(30) Foreign Application Priority Data
Jan. 10, 2018 (CN) 201810022602.5

(51) Int. Cl. G06Q 30/00; G06Q 40/04; G06Q 20/38; G06Q 50/06; G06Q 10/10; G07C 5/00; H04L 9/32; B60L 50/60

(52) U.S. Cl. CPC G06Q 30/018; G06Q 40/04; G06Q 20/389; G06Q 50/06; G06Q 10/10; B60Y 2200/92; G07C 5/008; H04L 9/3236; B60L 50/60; B60Y 2200/91; G06Q 20/3827

(57) ABSTRACT

Methods, devices, block chain nodes, computer readable media and a system for carbon recording and trading based on a block chain. A method for carbon recording and trading based on a block chain includes: obtaining data related to carbon behaviors of a plurality of objects; converting the data related to the carbon behaviors of the plurality of objects to corresponding carbon data of the plurality of objects, respectively; transmitting the carbon data to a block chain platform for storage; performing, based on the carbon data, a carbon trading between two objects in the plurality of objects or one object in the plurality of objects and a third party object not belonging to the plurality of objects; and distributing the carbon trading to the block chain platform as a block chain transaction.

### FIELD

The present disclosure generally relates to the field of carbon emission, and particularly to methods, a device, a block chain node, computer readable media and a system for carbon recording and trading based on a block chain.

### BACKGROUND

Greenhouse gases are some of the gases in the atmosphere that may absorb ground-reflected solar radiation and re-emit it. Carbon emissions are short for greenhouse gas emissions. Since the main gas in the greenhouse gases is carbon dioxide, the term “Carbon” is used. According to current research, greenhouse gases cause the surface temperature of the earth to rise, which effects and harms environment and climate. Therefore, how to control carbon emissions and how to reduce carbon emissions by emission reduction technologies have become one of the most important environmental issues at present.

### SUMMARY

Currently, data related to carbon behaviors (including carbon emission reduction behaviors (such as use of public bicycles, battery electrical vehicles, hybrid electrical vehicles) and carbon emission behaviors (such as energy consumption in a producing process of an enterprise)) of individuals and enterprises has various forms and does not subject to uniform equivalent conversion of carbon Emission Reductions (ER) or carbon emissions, resulting in confusion in carbon records. In addition, these carbon records are centrally stored in respective enterprises' proprietary databases, and there is no unified and credible platform for recording and thus the data may be tampered with.

Further, there is no credible third-party platform to implement and record the carbon trading based on these records of carbon emissions and carbon emission reductions.

In view of at least one of the above problems, the present disclosure provides a method and a system for carbon recording and trading based on a block chain.

According to a first aspect of the present disclosure, a method for carbon recording and trading based on a block chain is provided. The method includes: obtaining data related to carbon behaviors of a plurality of objects; converting the data related to the carbon behaviors of the plurality of objects to corresponding carbon data of the plurality of objects, respectively; transmitting the carbon data to a block chain platform for storage; performing, based on the carbon data, a carbon trading between two objects in the plurality of objects or between one object in the plurality of objects and a third party object not belonging to the plurality of objects; and distributing the carbon trading to the block chain platform as a block chain transaction.

According to a second aspect of the present disclosure, a device for carbon recording and trading based on a block chain is provided. The device includes a processor configured to: obtain data related to carbon behaviors of a plurality of objects, convert the data related to the carbon behaviors of the plurality of objects to corresponding carbon data of the plurality of objects, respectively, and transmit the carbon data to a block chain platform for storage, and wherein the processor is further configured to perform, based on the carbon data, a carbon trading between two objects in the plurality of objects or between one object among the plurality of objects and a third party object not belonging to the plurality of objects, and distribute the carbon trading to the block chain platform as a block chain transaction.

According to a third aspect of the present disclosure, a nonvolatile computer-readable medium for carbon recording and trading based on a block chain is provided. The nonvolatile computer-readable medium includes computer program codes for obtaining data related to carbon behaviors of a plurality of objects; computer program codes for converting the data related to the carbon behaviors of the plurality of objects to corresponding carbon data of the plurality of objects, respectively; computer program codes for transmitting the carbon data to a block chain platform for storage; computer program codes for performing, based on the carbon data, a carbon trading between two objects in the plurality of objects or between one object in the plurality of objects and a third party object not belonging to the plurality of objects; and computer program codes for distributing the carbon trading to the block chain platform as a block chain transaction.

According to a fourth aspect of the present disclosure, a method for carbon recording and trading based on a block chain is provided. The method includes converting, using a first smart contract, data related to carbon behaviors of a plurality of objects to corresponding carbon data of the plurality of objects, respectively, and transmitting, using the first smart contract, the carbon data to a block chain platform for storage; and performing, using a second smart contract, a carbon trading between two objects in the plurality of objects or between one object in the plurality of objects and a third party object not belonging to the plurality of objects based on the carbon data, and distributing, using the second smart contract, the carbon trading to the block chain platform as a block chain transaction.

According to a fifth aspect of the present disclosure, a block chain node for carbon recording and trading based on a block chain is provided. The block chain node includes a processor configured to convert, using a first smart contract, data related to carbon behaviors of a plurality of objects to corresponding carbon data of the plurality of objects, respectively, and transmit, using the first smart contract, the carbon data to a block chain platform for storage, and wherein the processor is further configured to perform, using a second smart contract, a carbon trading between two objects in the plurality of objects or between one object among the plurality of objects and a third party object not belonging to the plurality of objects based on the carbon data, and distribute, using the second smart contract, the carbon trading to the block chain platform as a block chain transaction

According to a sixth aspect of the present disclosure, a nonvolatile computer readable medium for carbon recording and trading based on a block chain. The nonvolatile computer readable medium includes computer program codes for converting, using a first smart contract, data related to the carbon behaviors of a plurality of objects to corresponding carbon data of the plurality of objects, respectively; computer program codes for transmitting, using the first smart contract, the carbon data to a block chain platform for storage; computer program codes for performing, using a second smart contract, a carbon trading between two objects in the plurality of objects or between one object in the plurality of objects and a third party object not belonging to the plurality of objects based on the carbon data; and computer program codes for distributing, using the second smart contract, the carbon trading to the block chain platform as a block chain transaction.

According to a seventh aspect of the present disclosure, a system for carbon recording and trading based on a block chain is provided. The system includes a processor configured to obtain data related to carbon behaviors of a plurality of objects; a first smart contract entity configured to convert, using a first smart contract, the data related to the carbon behaviors of the plurality of objects to corresponding carbon data of the plurality of objects, respectively, and transmit, using the first smart contract, the carbon data to a block chain platform for storage; and a second smart contract entity configured to perform, using a second smart contract, a carbon trading between two objects in the plurality of objects or between one object in the plurality of objects and a third party object not belonging to the plurality of objects based on the carbon data, and distribute, using the second smart contract, the carbon trading to the block chain platform as a block chain transaction.

With the solutions of the present disclosure, safe and credible recording of the carbon data may be achieved. Furthermore, according to some aspects of the present disclosure, safe and credible implementing and recording of the carbon trading may be achieved.

### BRIEF DESCRIPTION OF THE DRAWINGS

The present disclosure will be understood better and other objectives, details, features and advantages of the present disclosure will become more evident from description of specific embodiments of the disclosure given in conjunction with the following figures, wherein:

FIG. 1 illustrates a flow chart of a method for carbon recording and trading based on a block chain according to the present disclosure;

FIG. 2 illustrates a schematic view of a system for carbon recording and trading based on a block chain according to the present disclosure;

FIG. 3A illustrates a schematic view of the storage format in the block chain storage of the carbon data according to the present disclosure; and

FIG. 3B illustrates a schematic view of the storage format in the distributed storage database of the carbon data according to the present disclosure.

### DETAILED DESCRIPTION OF THE PREFERRED EMBODIMENTS

Embodiments of the present disclosure will now be described in more detail with reference to accompanying figures. Although embodiments of the present disclosure are shown in the accompanying figures, it should be understood that the present disclosure can be embodied in various ways but not be limited to embodiments depicted herein. Instead, embodiments provided herein are to make the disclosure more thorough and completely convey the scope of the present disclosure to those skilled in the art.

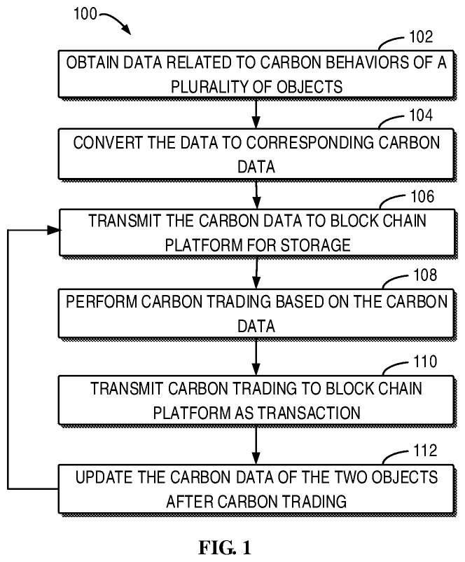

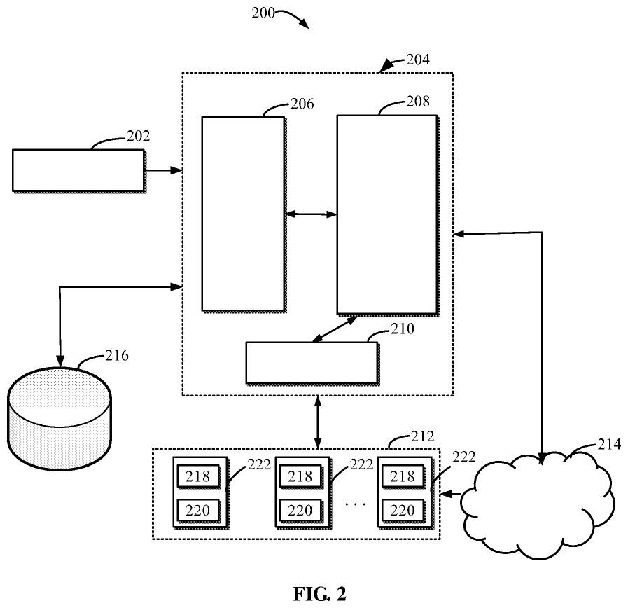

FIG. 1 illustrates a flow chart of the method 100 for carbon recording and trading based on a block chain according to the present disclosure. The method 100 may be implemented, for example, by the system 200 for carbon recording and trading shown in the following FIG. 2.

As shown in FIG. 1, the method 100 includes a step 102 in which data related to carbon behaviors of a plurality of objects is obtained.

Herein, depending to whether an object is a resource consuming object or a resource saving object, data related to the carbon behaviors of the object may be different.

In one implementation, the plurality of objects includes a first object which is a resource saving object. For example, the first object may be a new energy vehicle (including a Battery Electrical Vehicle (BEV), a Hybrid Electrical Vehicle (HEV)) or a public bicycle, or a user of the new energy vehicle or the public bicycle, where what is concerned is the carbon emission reduction amount thereof. In this case, the obtained data related to the carbon behaviors of the first object is the distance travelled by the new energy vehicle or the public bicycle.

Alternatively, the first object may also be a provider of the new energy vehicles or a provider of the public bicycles. In this case, the obtained data related to carbon behaviors of a first object may be a sum of the data related to carbon behaviors of all the new energy vehicles provided by the provider or all the public bicycles provided by the provider.

In one implementation, the plurality of objects includes a second object which is a resource consuming object. For example, the second object may be an enterprise with an excessive carbon emission and the like, and what is concerned by it is the carbon emission amount or the excessive amount of the carbon emission. In this case, the obtained data related to the carbon behaviors of the second object is the usage amount of emission source of such an enterprise.

At step 104, the data related to the carbon behaviors of the plurality of objects obtained at step 102 is converted to the corresponding carbon data, respectively. Here, the carbon data includes the carbon emission reduction amount of the first object and the carbon emission amount of the second object as described above.

The conversion at step 104 may be performed in the processor 208 of the local device 204 as described below, and may also be performed on the block chain platform 212 as described below.

If step 104 is performed on the block chain platform 212, a smart contract (such as the first smart contract 218 shown in FIG. 2) dedicated to performing the conversion may be developed and distributed to the block chain platform 212, for example, to a plurality of block chain nodes 222 on the block chain platform 212. Here, the block chain nodes 222 may be regarded as hosts of the first smart contract 218, and are also referred to as the first smart contract entity 218 herein. In this case, the data related to the carbon behaviors of the plurality of objects is transmitted to the first smart contract entity 218 on the block chain platform 212, and the data related to the carbon behaviors of the objects is converted to the corresponding carbon data using the first smart contract entity 218. The first smart contract 218 may be contracted by each object whose carbon record is to be recorded and distributed to the entire block chain platform 212 or a portion of the block chain platform 212. The first smart contract 218 may be developed by a developer of the system 200 or other providers and may be regarded as part of the system 200.

By performing the conversion of the carbon data using a smart contract on the block chain platform, a secure and credible third-party security assurance may be provided.

Here, the conversion of the data related to the carbon behaviors of the objects to the carbon data may be implemented by any method known in the art or to be developed in the future.

For example, for the first object described above, the carbon data includes the carbon emission reduction amount. The conversion of step 104 may include calculating a carbon emission reduction amount of the first object based on a Baseline Emission (BE) amount and a Project Emission (PE) amount of the first object. More specifically, the carbon emission reduction (ER) amount may be calculated according to the following formula:

ER=BE−PE,

where BE indicates a presumed emission amount of the first object under a baseline behavior, and PE indicates an actual emission amount of the first object under an emission reduction behavior. For example, for a new energy vehicle, BE indicates the presumed emission amount using a conventional fuel and PE indicates the actual emission amount generated by using electrical energy or hybrid energy. Of course, the calculation of the carbon emission reduction amount may also be related to other factors, such as leakage emissions, vehicle types, fuel types and so on, which will not be described in detail herein. In the case where the first object is a public bicycle or a user of a public bicycle, PE may be regarded as zero.

As another example, for the second object above, the carbon data includes the carbon emission amount. The conversion at step 104 may include calculating the carbon emission amount of the second object based on the usage amount of an emission source of the second object and the emission factor corresponding to the emission source. More specifically, the carbon emission amount may be calculated according to the following formula:

Carbon Emission=Usage Amount of Emission Source*Emission Factor,

where the usage amount of the emission source indicates the amount of the emission source consumed by the second object, and the emission factor corresponding to the emission source indicates the coefficient of generating carbon emission during consumption of the emission source. The emission source includes, for example, coal, oil, natural gas, and the like. Of course, the calculation of the carbon emission amount may also be related to other factors, such as whether emission reduction measures are adopted and so on, which will not be described in detail herein.

At step 106, the carbon data obtained at step 104 is transmitted to the block chain platform 212 for storage. Here, in case that the conversion at step 104 is performed by the processor 208 of the device 204, the carbon data is distributed to the block chain platform 212 by the processor 208 via the transceiver 206 and the wired or wireless network 214, for example. On the other hand, in case that the conversion at step 104 is performed by the first smart contract entity 218, the carbon data is distributed directly from the first smart contract entity 218 to the block chain platform 212. Secure and credible storage of the carbon data is achieved by storing the carbon data on the block chain platform 212.

In one implementation, the carbon data transmitted to the block chain platform 212 at step 106 is raw carbon data obtained from the conversion at step 104. However, in case that large amounts of raw carbon data is present, storing all these carbon data directly onto the block chain platform 212 will occupy relatively large amount of block chain storage and result in higher storage costs.

To address this issue, the carbon data of an object may be stored by combining the block chain storage with distributed database storage. Specifically, at step 106, a Hash operation may be performed on the carbon data converted at step 104, and the result of the Hash operation (that is, the hashed value of the carbon data) and the unique identification number of the object may be transmitted to the block chain platform 212 for storage. The raw carbon data may be stored by the system 200 in a local memory or a distributed database (such as the database 216 shown in FIG. 2).

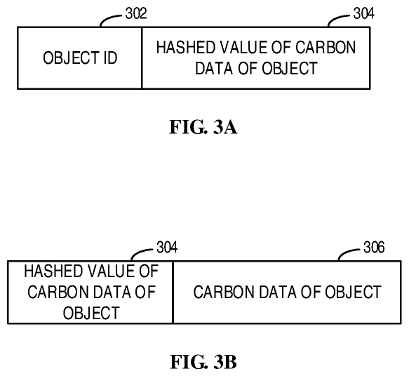

FIG. 3A illustrates a schematic view of the storage format in the block chain storage of the carbon data according to the present disclosure and FIG. 3B illustrates a schematic view of the storage format in the distributed storage database of the carbon data according to the present disclosure. As shown in FIG. 3A, on the block chain platform 212, a list of correspondence between a unique identification number (ID) 302 of an object and the hashed value 304 of the carbon data of the object is stored. As shown in FIG. 3B, in the distributed database (such as the database 216 shown in FIG. 2), a list of correspondence between the carbon data 306 of the object converted at step 104 and the hashed value 304 of the carbon data 306 of the object is stored.

In one implementation, the unique identification number may be assigned by the system 200 to each object. In another implementation, a Hash operation may be performed on some specific information of an object and the hashed value may be used as a unique identification number for that object. For example, if the object is a battery electrical vehicle or a hybrid electrical vehicle, a Hash operation may be performed on the frame number or the license plate number of the battery electrical vehicle or the hybrid electrical vehicle, and the result of the Hash operation (that is, the hashed value of the frame number or the license plate number) may be used as the unique identification number of the object. As another example, if the object is a public bicycle, a Hash operation may be performed on the license plate number of the bicycle and the result of the Hash operation (that is, the hashed value of the license plate number) may be used as the unique identification of the bicycle. On the other hand, if the object is a user of a new energy vehicle or a public bicycle, the user's resident identification card number or mobile phone number or its hashed value may be used as the unique identification number of the object.

After the carbon recording steps 102 to 106 as described above, the method 100 may further include a carbon trading step 108. Carbon trading may be performed between two of the plurality of objects or between one object in the plurality of objects and a third party object not belonging to the plurality of objects. A smart contract (such as the second smart contract 220 shown in FIG. 2) dedicated to performing the carbon trading may be developed and distributed to the block chain platform 212, for example, to the plurality of block chain nodes 222 on the block chain platform 212. Here, the block chain nodes 222 may be regarded as hosts of the second smart contract 220, and are also referred to as the second smart contract entity 220 in the present disclosure. In this case, the second smart contract entity 220 performs the carbon trading between the first object and the second object based on, for example, the carbon data of the first object (e.g., the carbon emission reduction amount) and the carbon data (e.g., the carbon emission amount) of the second object. The second smart contract 220 may be contracted by each object to perform the carbon trading and distributed to the entire block chain platform 212 or a portion of the block chain platform 212. The second smart contract 220 may be developed by a developer of the system 200 or other providers and may be regarded as part of the system 200. It may be understood by those skilled in the art that each block chain node 222 may be implemented as a computer device including one or more processors (not shown) which may be used to execute the first smart contract 218 and/or the second smart contract 220.

The carbon trading between the first object and the second object may be distributed to the block chain platform 212 as a block chain transaction (step 110) so that the content of the carbon trading between different objects is also certificated on the block chain platform and trading information is prevented from being tampered with.

Similar to the storage of carbon data as described above, the storage of information on the carbon trading may also be implemented by the combination of the block chain storage and the distributed database storage, which will not be described in detail herein.

FIG. 2 illustrates a schematic view of the system 200 for carbon recording and trading based on a block chain according to the present disclosure. As shown in FIG. 2, the system 200 includes a local device (for example, a server) 204 that includes a processor 208 and a transceiver 206. The processor 208 is configured to retrieve, from the data source 202 via the transceiver 206, data related to the carbon behaviors of the plurality of objects. Those skilled in the art may understand that the data source 202 may be a part of the system 200, or may be an external entity independent of the system 200. The data in the data source 202 may be collected using intelligent Internet of Things (IoT) technologies to ensure that the source of the collected data is credible.

In one implementation, the processor 208 may be configured to convert the data related to the carbon behaviors of the plurality of objects to the corresponding carbon data, respectively, and to transmit the resulting carbon data to the block chain platform 212 for storage, for example, via a wired or wireless network 214.

In another implementation, the conversion may be performed in a smart contract (such as the first smart contract 218 shown in FIG. 2) on the block chain platform 212. In this case, the processor 208 transmits the data related to the carbon behaviors (for example, via the block chain application interface 210) to the first smart contract entity 218 on the block chain platform 212 and the first smart contract entity 218 converts the data related to the carbon behaviors of the objects to the corresponding carbon data and distribute to the block chain platform 212.

Similarly, the carbon data transmitted to the block chain platform 212 for storage may be the raw carbon data converted by the processor 208 or the first smart contract entity 218, or may be the hashed values of the carbon data. Specifically, the processor 208 may perform a Hash operation on the converted carbon data (the carbon data directly converted or obtained from the first smart contract entity 218) and transmit the result of the Hash operation (that is, the hashed value of the carbon data) and the unique identification number of the object to the block chain platform 212 for storage. The raw carbon data may be stored by the system 200 in a local memory (not shown) or in a distributed database 216. It is to be appreciated that the distributed database 216 may be part of the system 200 or may be an external database independent of the system 200.

Furthermore, the system 200 may also perform a carbon trading between two objects in the plurality of objects or between one object in the plurality of objects and a third party object not belonging to the plurality of objects and distribute the carbon trading to the block chain platform 212 as a block chain transaction. Specifically, the system 200 may include a second smart contract entity 220 dedicated to performing a carbon trading based on, for example, the carbon data (for example, the carbon emission reduction amount) of the first object and the carbon data (for example, the carbon emission amount) of the second object to perform carbon trading between the first object and the second object. The second smart contract 220 may be contracted by each object to perform the carbon trading and distribute to the entire block chain platform 212 or a portion of the block chain platform 212. The second smart contract 220 may be developed by a developer of the system 200 or other providers and may be regarded as part of the system 200.

In addition, before performing the carbon trading, the system 200 (the processor 208 or the first smart contract entity 218 or another smart contract entity) may further convert the corresponding carbon data of the plurality of objects to the corresponding carbon assets, so that the carbon trading may be implemented between the two objects or the one object and the third party object based on the carbon assets.

The carbon assets may be positive or negative. For example, an object with a positive carbon asset indicates that the carbon emission amount of the object is below a predetermined quota through its carbon emission reduction behaviors, and an object with a negative carbon asset indicates that the carbon emission amount of the object exceeds its quota. According to current carbon emission policy, it is required for an enterprise whose carbon emission amount has exceeded its quota to buy carbon emission quota from another enterprise or organization to meet the requirements for its development. It may be appreciated by those skilled in the art that whether to indicate the carbon asset with a positive value or a negative value is only for purpose of illustration and not intended to limit the present disclosure. In actual implementation, any other feasible manner may be used to distinguish the carbon assets of different objects.

Herein, if the carbon trading is performed between two objects in the plurality of objects, such a carbon trading is also referred to as “carbon exchange”, while if the carbon trading is performed between one object among the plurality of objects and the third party object, such a carbon trading is also referred to as “carbon transfer.” For carbon exchange, the two parties involved in the carbon trading should have positive carbon asset and negative carbon asset, respectively. For carbon transfer, the vendor of the carbon trading should have a positive carbon asset and the carbon asset of the third party object is not concerned. That is, a third party object may buy the carbon asset through the system 200 even if no carbon data of the third party object is recorded in the system 200. In this case, the carbon asset may be regarded as a general commodity.

In one implementation, performing carbon trading between two objects based on the carbon assets thereof may include performing the carbon trading directly between a first object with a positive carbon asset and a second object with a negative carbon asset. In this case, an enterprise with a negative carbon asset may buy the carbon emission quota from another enterprise with a positive carbon asset directly in the system 200 (the processor 208 or the second smart contract entity 220 or another smart contract entity).

In another implementation, performing carbon trading between two objects based on the carbon assets thereof may include performing the carbon trading indirectly through the system 200 (the processor 208 or the second smart contract entity 220 or another smart contract entity). In particular, on one hand, the system 200 may obtain a first amount of carbon asset from a first object with a positive carbon asset and provide the first object with a reward corresponding to the first amount of carbon asset. On the other hand, the system 200 may provide a second amount of carbon asset to a second object with a negative carbon asset and charge an income corresponding to the second amount of carbon asset from the second object. Alternatively, the system 200 may provide a second amount of carbon asset to a third party object and charge an income corresponding to the second amount of carbon asset from the third party object. Here, the first amount may be identical to or different from the second amount.

Here, the carbon asset may be in a form of carbon credit or carbon coin. In this case, the object with a positive carbon asset may transfer its carbon credit or carbon coin to the system 200 and get a reward from the system 200. For example, if the user of the new energy vehicle or public bicycle is the first object, he/she may transfer his/her carbon credit or carbon coin obtained through his/her carbon emission reduction behaviors to the system 200 which may, in turn, provide an online or offline certificate or coupon for a specific commodity to the user. On the other hand, the object with a negative carbon asset may pay the system 200 its carbon credit or carbon coin to get carbon assets from the system 200. Alternatively, the third party object without a carbon asset may pay the system 200 in any other manners to obtain carbon assets from the system 200.

In one implementation, the conversion from the carbon data to the carbon assets may be performed immediately following the step 104. In this case, at step 106, the carbon assets of the objects may be transmitted to the block chain platform 212 for storage.

Furthermore, the method 100 may further include step 112 in which the carbon data of the two objects or the one object may be updated after the carbon trading. Subsequently, the method 100 may go to step 106 to transmit the updated carbon data to the block chain platform 212 for storage.

Similarly, in case that the carbon trading is performed based on the carbon assets, the carbon assets of the two objects or one object may be updated at the step 112, and the updated carbon assets are transmitted to the block chain platform 212 for storage.

In one or more exemplary designs, the functions described by the present disclosure may be implemented in hardware, software, firmware, or any combination thereof. If implemented in software, the functions may be stored on or transmitted over as one or more instructions or codes on a computer-readable medium.

The various units of the device described herein may be implemented with discrete hardware components or integrally in a single hardware component such as a processor. For example, the various illustrative logical blocks, modules, and circuits described in connection with the aspects disclosed herein may be implemented within or performed by a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

Those skilled in the art would further appreciate that any of the various illustrative logical blocks, modules, processors, means, circuits, and algorithm steps described in connection with the aspects disclosed herein may be implemented as electronic hardware, computer software, or combinations of both.

The previous description is provided to enable any person skilled in the art to make or use the present disclosure. Various modifications to the present disclosure will be readily apparent to those skilled in the art, and the generic principles defined herein may be applied to other aspects without departing from the scope of the disclosure. Thus, the present disclosure is not intended to be limited to the examples and designs shown herein but is to be accorded the widest scope consistent with the principles and novel features disclosed herein.

1.-37. (canceled)

38. A method of carbon recording and trading performed with at least one block chain node, the method comprising:
obtaining, at the block chain node, use data corresponding to the use of an electric vehicle and a unique ID of the electric vehicle, wherein the use data includes at least one of a distance traveled by the electric vehicle or an amount of electrical energy consumed by the electric vehicle;
converting, by at least one smart contract executed by the block chain node, the use data to a carbon emission reduction value, wherein the converting includes:
determining a baseline carbon emission amount, BE, corresponding to a use of a combustion engine vehicle according to the use data;
determining an actual carbon emission amount, PE, caused by the use of the electric vehicle according to the use data; and
subtracting PE form BE;
writing, with the block chain node, the carbon emission reduction value and the unique ID to a block chain as a block chain transaction;
generating, by the at least one smart contract, a carbon credit according to the carbon emission reduction value;
writing, with the block chain node, the carbon credit and the unique ID to the block chain as a block chain transaction;
receiving, at the block chain node, a request for a transaction to purchase a good or service with the carbon credit; and
executing, with the at least one smart contract, a block chain transaction according to the request.

39. The method of claim 38, wherein the writing the carbon emission reduction value and the unique ID to the block chain includes performing a Hash operation on the carbon emission reduction value to obtain a Hashed value of the carbon emission reduction value; and transmitting the Hashed value of the carbon emission reduction value to the block chain for storage.

40. The method of claim 38, wherein the electric vehicle includes at least one of a battery electric vehicle or a hybrid electric vehicle.

41. The method of claim 38, wherein the use data is collected by an IoT sensor operably coupled to the electric vehicle and transmitted to the block chain node via a computing device located in the electric vehicle.

42. A block chain node for carbon recording and trading, comprising:
a processor; and
a memory containing computer readable instructions for causing the processor to perform operations, comprising:
obtaining use data corresponding to the use of an electric vehicle, and a unique ID of the electric vehicle, wherein the use data includes at least one of a distance traveled by the electric vehicle or an amount of electrical energy consumed by the electric vehicle;
converting, by at least one smart contract executed by the block chain node, the use data to a carbon emission reduction value, wherein the converting includes:
determining a baseline carbon emission amount, BE, corresponding to a use of a combustion engine vehicle according to the use data;
determining an actual carbon emission amount, PE, caused by the use of the electric vehicle according to the use data; and
subtracting PE form BE;
writing, with the block chain node, the carbon emission reduction value and the unique ID to a block chain as a block chain transaction;
generating, by the at least one smart contract, a carbon credit according to the carbon emission reduction value;
writing, with the block chain node, the carbon credit and the unique ID to the block chain as a block chain transaction;
receiving, at the block chain node, a request for a transaction to purchase a good or service with the carbon credit; and
executing, with the at least one smart contract, a block chain transaction according to the request.

43. The block chain node of claim 42, wherein the writing the carbon emission reduction value and the unique ID to the block chain includes performing a Hash operation on the carbon emission reduction value to obtain a Hashed value of the carbon emission reduction value; and transmitting the Hashed value of the carbon emission reduction value to the block chain for storage.

44. The block chain node of claim 42, wherein the electric vehicle includes at least one of a battery electric vehicle or a hybrid electric vehicle.

45. The block chain node of claim 42, wherein the use data is collected by an IoT sensor operably coupled to the electric vehicle and transmitted to the block chain node via a computing device located in the electric vehicle.

46. A method of carbon recording and trading performed with at least one block chain node, the method comprising:
obtaining, at the block chain node, use data corresponding to the use of an electric vehicle, and a unique ID of the electric vehicle, wherein the use data includes at least one of a distance traveled by the electric vehicle or an amount of electrical energy consumed by the electric vehicle;
obtaining, at the block chain node, an energy consumption amount by an entity, an emission source type, and a unique ID of the entity;
converting, by at least one smart contract executed by the block chain node, the use data to a carbon emission reduction value, wherein the converting includes:
determining a baseline carbon emission amount, BE, corresponding to a use of a combustion engine vehicle according to the use data;
determining an actual carbon emission amount, PE, caused by the use of the electric vehicle according to the use data; and
subtracting PE form BE;
converting, by the at least one smart contract executed by the block chain node, the energy consumption amount to a carbon emission value, wherein the converting includes:
determining an emission factor according to the emission source type, wherein the emission factor is a correlation between emission generation and consumption of the emission source;
calculating the carbon emission amount according to the energy consumption amount and the emission factor;
writing, with the block chain node, the carbon emission reduction value and the carbon emission value to a block chain as a block chain transaction;
generating, by the at least one smart contract, a carbon credit according to the carbon emission reduction value;
writing, with the block chain node, the carbon credit and the electric vehicle unique ID to the block chain as a block chain transaction;
generating, by the at least one smart contract, a negative carbon credit according to the carbon emission value;
writing, with the block chain node, the negative carbon credit and the entity unique ID to the block chain as a block chain transaction;
receiving, at the block chain node, a request for a carbon credit trade between the electric vehicle and the entity to transfer the carbon credit to the entity; and
executing, with the at least one smart contract, a block chain transaction according to the request, wherein the executing includes updating the electric vehicle's and the entity's carbon credits on the block chain according to the block chain transaction.

47. The method of claim 46, wherein the writing the carbon emission reduction value and the electric vehicle unique ID to the block chain includes performing a Hash operation on the carbon emission reduction value to obtain a Hashed value of the carbon emission reduction value; and transmitting the Hashed value of the carbon emission reduction value to the block chain platform for storage, further wherein the writing the carbon emission value and the entity unique ID to the block chain includes performing a Hash operation on the carbon emission value to obtain a Hashed value of the carbon emission value and transmitting the Hashed value of the carbon emission value to the block chain platform for storage.

48. The method of claim 46, wherein the electric vehicle includes at least one of a battery electric vehicle or a hybrid electric vehicle.

49. The method of claim 46, wherein the use data is collected by an IoT sensor operably coupled to the electric vehicle and transmitted to the block chain node via a computing device located in the electric vehicle.
